(19) United States
(12) Patent Application Publication
(10) Pub. No.: US 2017/0297851 A1
(43) Pub. Date: Oct. 19, 2017

(54) APPLIED CONSTRUCTIVE HEAD LAYOUT FOR STRUCTURAL GLAZING SYSTEM

(71) Applicant: VTECH Comércio de Esquadrias e Vidros Ltda. EPP, São Pedro de Alcantara (BR)

(72) Inventor: Marcelo Stahelin, Sao Pedro de Alcantara (BR)

(21) Appl. No.: 15/485,407

(22) Filed: Apr. 12, 2017

(30) Foreign Application Priority Data
Apr. 13, 2016 (BR) BR 10 2016 008166

(51) Int. Cl. B65H 23/032; B65H 20/02; B65H 35/04; E06B 3/56

(52) U.S. Cl. CPC B65H 23/032; B65H 35/04; B65H 20/02; E06B 3/56

(57) ABSTRACT

Refers to the present invention, a device (1) that will be fabricated with appropriate material, with several dimensions, to be adapted to a computerized numeric platform, for the structural glazing process, which is a technique of fixing the glass and the frame, through application of the high adhesion double-sided tape between them, the structure remains hidden on the inner side, in two basic steps, one being application and cutting of the high adhesion double-sided tape over the glass sheet, and the other is (applying) correct pressure on them, for the purpose of replacing the current manual process.

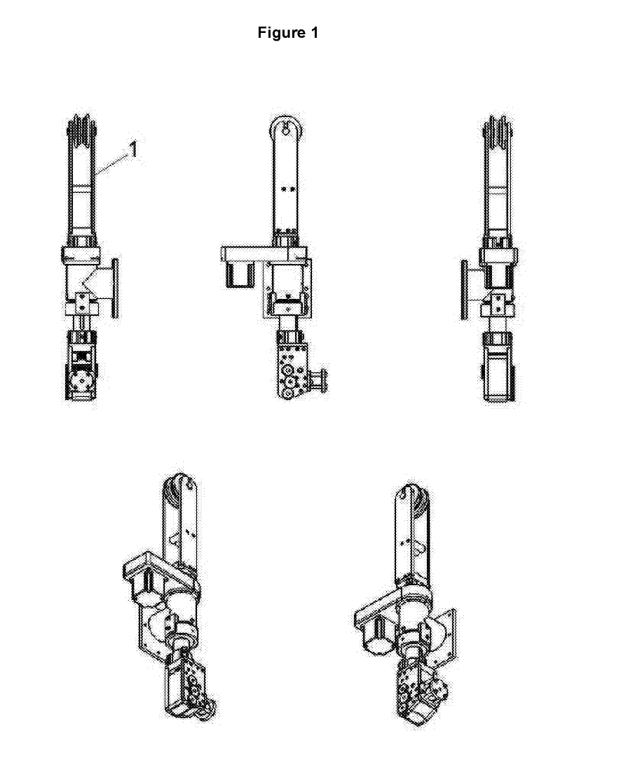

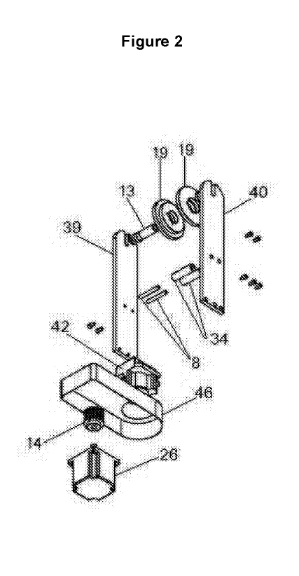

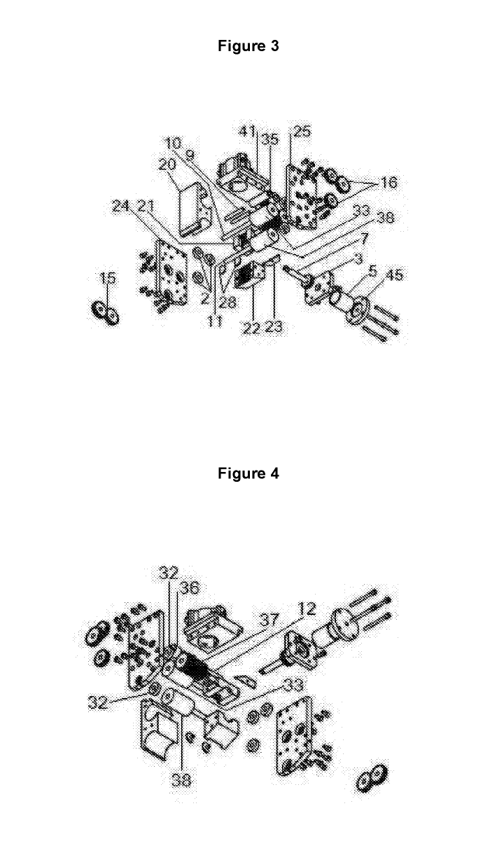

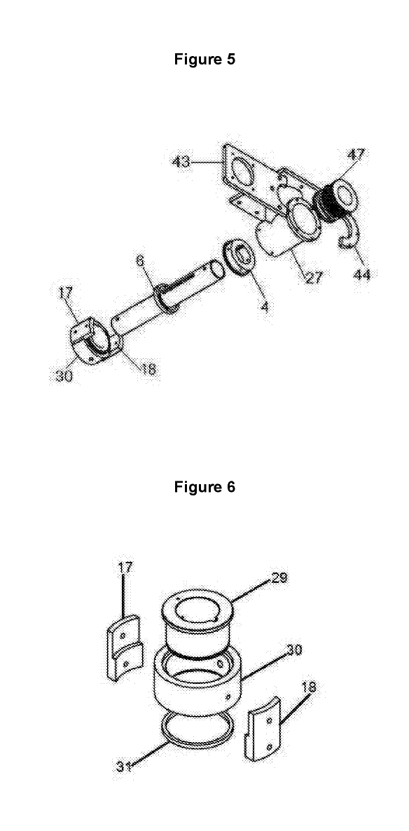

Referring to the current invention, a device that will be fabricated with appropriate material, with several dimensions, to be adapted to a computerized numeric platform, for the structural glazing process, which is a technique of fixing the glass and the frame, through application and cutting of the high adhesion double-sided tape between them, the structure remains hidden on the inner side, using this technique, whenever we take a look at the frame from the outer side we only see the glass and from the inner side we are able to see only the frame and glass

No similar device has been found in the feasibility research that was conducted in the field of application, that had the same or similar concepts and functioning compared to the device presented in question.

The device presented here, has the purpose of replacing the manual process that is currently used, eliminating human effort, labor, saving time and raw material, reduced energy consumption, technically modernizing this process with safety and quality, gradually increasing the productivity

The device operates in two basic steps, the application of the high adhesion double-sided tape over the glass sheet and the cutting of the tape with the specific numeric coordinate x, y and z at the computerized numeric platform, where the device accurately applies tape to the glass thus automatically applying and trimming it, the other step is applying the correct pressure on them which is determined by the tape manufacturer, also determined by the numeric coordinates x, y and z, over the frame and the glass, running through all its perimeter, providing the adequate fusion between frame, tape and glass.

Hereafter, the current device which comprises of an upper part, a lower part, and an inner part which is constituted by the following parts: centralizing flange washer (2); Cylinder fixing base (3); bronze bushing of the main neck of the head (4); cylinder body (5); core shaft of the head (6); cylinder shaft (7); upper polypropylene roller shaft 34 (8); lower polypropylene roller shaft 35 (9); rubber roller shaft 33 (10); smooth traction roller shaft 38 (11);traction roller shaft 37 (12); tape stand shaft (13); step motor gear (14); gear of the smooth traction roller shaft 38 (15); gear of the rubber traction roller shaft 33 and the smooth traction roller shaft 38 (16); air gripper 1 (17); air gripper 2 (18); centralizing flange of the tape roll (19); tape guide 1 (20); tape guide 2 (21); tape guide 3 (22); cutting blade of the cylinder shaft tip (23); side 1 (24); side 2 (25); step motor (26); main neck of the head (27); limiting pin of the tape guide 3 (28); air system part 1 (29); air system part 2 (30); air system part 3 (31); side bearing 1 and 2 (32); rubber roller (33); upper polypropylene roller (34); lower polypropylene roller (35); roll guide (36); traction roller (37); smooth traction roller (38); tape stand 1 side 1 (39); tape stand 1 side 2 (40); lower pipe bracket of the core shaft of the head (41); upper pipe bracket 1 of the core shaft of the head (42); step motor stand 1 (43); step motor stand 2 (44); cylinder lid (45); step motor protection lid (46); transmission for the conveyor belt with 49 teeth (47) and will be described in complete details, in accordance with the attached images where:

Image 1 shows all views of the mentioned device (1) assembled, showing all its sides;

Image 2 shows a perspective exploded view of the upper part of the said device (1), showing its following parts: upper polypropylene roller shaft 34 (8); tape roll holder shaft (13); step motor gear (14); centralizing flange of the tape roll (19); step motor (26); upper polypropylene roller (34); tape stand 1 side 1 (39); tape stand 1 side 2 (40); upper pipe bracket 1 of the core shaft of the head (42); step motor protection lid (46).

Image 3 shows an exploded perspective view of the lower part of the said device (1), with its following parts: centralizing flange washer (2); cylinder fixing base (3); cylinder body (5); cylinder shaft (7); lower polypropylene roller shaft 35 (9); rubber roller shaft 33 (10); smooth traction roller shaft 38 (11); gear of the smooth traction roller shaft 38 (15); gear of the rubber traction roller shaft 33 and smooth traction roller gear 38 (16); tape guide 1 (20); tape guide 2 (21); tape guide 3 (22); cutting blade of the cylinder shaft tip (23); side 1 (24); side 2 (25); limiting pin of the tape guide 3 (28); rubber roller (33); lower polypropylene roller (35); smooth traction roller (38); lower pipe bracket of the core shaft of the head (41); cylinder lid (45).

Image 4 shows a continuation of the exploded perspective view of the lower part of the said device (1), with its following parts: traction roller shaft 37 (12); side bearing 1 and 2 (32); rubber roller (33); roll guide (36); traction roller (37); smooth traction roller (38);

Image 5 shows an exploded perspective view of the inner part of the said device (1), with its following parts: bronze bushing of the main neck of the head (4); core shaft of the head (6); air gripper 1 (17); air gripper 2 (18); main neck of the head (27); air system part 2 (30); step motor stand 1 (43); step motor stand 2 (44); transmission for the conveyor belt with 49 teeth (47);

Image 6 shows a continuation of the exploded perspective view of the inner part of the said device (1), with its following parts: air gripper 1 (17); air gripper 2 (18); air system part 1 (29); air system part 2 (30); air system part 3 (31).

The operation of the first stage of the device (1), this invention object, is started every time by the operator, using the numeric command, with x, y and z coordinates, inserted on the computerized platform, inserts the high adhesion double-sized tape between the tape roller of the centralizing flanges (19), position the rubber roller (33) leaning against a surface, it is, then automatically pushed and mechanically moves through the traction roller gears (37) and (38) pulling the adhesive tape that is going to be fixed, which is determined by the operator himself, then the pneumatic cylinder (5) cuts the tape, using the cutting blade of the cylinder shaft tip (23) and the rubber roller (33) is then pushed further to position the tape for the next one to be fixed, then the entire device lifts up and is ready to be positioned again and start the whole process.

The operation of the second stage of the device (1), this invention object, is started every time by the operator, using the numeric command with x, y and z coordinates inserted in the computerized platform, this time without the high adhesion tape, the said device (1) will press both parts that have been bonded by the tape, fixing them permanently, running only through the specific path determined by the coordinates

Based on researches done, we described and illustrated the device (1) and we conclude that it has technical, constructive and functional features of originality and novelty, which are not found in the technical industry, fitting in the criteria that define an Invention Patent, therefore being a new practical and efficient solution for the structural glazing process.

1) APPLIED CONSTRUCTIVE HEAD LAYOUT FOR STRUCTURAL GLAZING SYSTEM constituted for being a device (1) that will be fabricated with appropriate material, in several dimensions, to be adapted to a computerized numeric control platform, for structural glazing process, with the purpose of replacing the manual process that is currently being used and it is characterized by having an upper part, a lower part and an internal part, constituted by the following parts: centralizing flange washer (2); Cylinder fixing base (3); bronze bushing of the main neck of the head (4); cylinder body (5); core shaft of the head (6), cylinder shaft (7); upper polypropylene roller shaft 34 (8); lower polypropylene roller shaft 35 (9); rubber roller shaft 33 (10) smooth traction roller shaft 38 (11); traction roller shaft 37 (12); tape roll holder shaft (13); step motor gear (14); gear of the smooth traction roller shaft 38 (15); gear of the rubber traction roller shaft 33 and smooth traction roller gear 38 (16); air gripper 1 (17); air gripper 2 (18); centralizing flange of the tape roll (19); tape guide 1 (20); tape guide 2 (21); tape guide 3 (22); cutting blade of the cylinder shaft tip (23); side 1 (24); side 2 (25); step motor (26); main neck of the head (27); limiting pin of the tape guide 3 (28); air system part 1 (29); air system part 2 (30); air system part 3 (31); side bearing 1 and 2 (32); rubber roller (33); upper polypropylene roller (34); lower polypropylene roller (35); roll guide (36); traction roller (37); smooth traction roller (38); tape stand 1 side 1 (39); tape stand 1 side 2 (40); lower pipe bracket of the core shaft of the head (41); upper pipe bracket 1 of the core shaft of the head (42); step motor stand 1 (43); step motor stand 2 (44); cylinder lid (45); step motor protection lid (46) and transmission for the conveyor belt with 49 teeth (47);

2) APPLIED CONSTRUCTIVE HEAD LAYOUT FOR STRUCTURAL GLAZING SYSTEM according to the claim 1) the upper part is characterized by comprising of the upper polypropylene roller shaft 34 (8); tape roll holder shaft (13); step motor gear (14); centralizing flange of the tape roll (19); step motor (26); upper polypropylene roller (34); tape stand 1 side 1 (39); tape stand 1 side 2 (40); upper pipe bracket 1 of the core shaft of the head (42) and step motor protection lid (46);

3) APPLIED CONSTRUCTIVE HEAD LAYOUT FOR STRUCTURAL GLAZING SYSTEM according to the claim 1) the lower part is characterized by comprising of the centralizing flange washer (2); Cylinder fixing base (3); cylinder body (5); cylinder shaft (7); lower polypropylene roller shaft 34 (9); rubber roller shaft 33 (10); smooth traction roller shaft 38 (11); gear of the smooth traction roller shaft 38 (15); gear of the rubber traction roller shaft 33 and smooth traction roller gear 38 (16); tape guide 1 (20); tape guide 2 (21); tape guide 3 (22); cutting blade of the cylinder shaft tip (23); side 1 (24); side 2 (25); limiting pin of the tape guide 3 (27); rubber roller (33); lower polypropylene roller (35); smooth traction roller (38); lower pipe bracket of the core shaft of the head (41); cylinder lid (45); smooth traction roller shaft 37 (12); side bearing 1 and 2 (32); roll guide (36) and traction roller (37);

4) APPLIED CONSTRUCTIVE HEAD LAYOUT FOR STRUCTURAL GLAZING SYSTEM according to the claim 1) the core part is characterized by comprising of bronze bushing of the main neck of the head (4); head of the core shaft (6); air gripper 1 (17); air gripper 2 (18); main neck of the head (27); air system part 2 (30) step motor stand 1 (43); step motor stand 2 (44); transmission for the conveyor belt with 49 teeth (47); air system part 1 (29) and air system part 3 (31).

5) APPLIED CONSTRUCTIVE HEAD LAYOUT FOR STRUCTURAL GLAZING SYSTEM according to the claim 1 characterized by initiating the operation of the first stage of the device (1), every time by the operator, through the numeric command with coordinates x, y and z inserted in the computerized platform, insert the high adhesion double-sided tape between the tape roller of the centralizing flanges (19), position the rubber roller (33) leaning against a surface, it is then automatically pushed and mechanically moves through the traction roller gears (37) and (38) pulling the adhesive tape that is going to be fixed, which is determined by the operator himself, there the pneumatic cylinder (5) cuts the tape, using the cutting blade of the cylinder shaft tip (23) and the rubber roller (33) is pushed further to position the tape for the next one to be fixed, then the entire device lifts up and is ready to be positioned again and start the whole process

6) APPLIED CONSTRUCTIVE HEAD LAYOUT FOR STRUCTURAL GLAZING SYSTEM according to the specification 1 characterized by initiating the operation of the second stage of the device (1), every time by the operator, through the numeric command with coordinates x, y and z inserted in the computerized platform, without the high adhesion tape, the device itself (1) will press both parts that have been bonded by the tape, fixing them permanently, running only through the specific path determined by the coordinates
